(19) United States
(12) Patent Application Publication
(10) Pub. No.: US 2024/0306109 A1
(43) Pub. Date: Sep. 12, 2024

(54) POSITION DETERMINATION METHOD, SYNCHRONIZATION METHOD, DEVICE, APPARATUS AND TERMINAL

(71) Applicant: DATANG GOHIGH INTELLIGENT AND CONNECTED TECHNOLOGY (CHONGQING) CO., LTD., Chongqing (CN)

(72) Inventors: Haijun ZHOU, Chongqing (CN); Peng WANG, Chongqing (CN); Xiaoxu FENG, Chongqing (CN)

(73) Assignee: DATANG GOHIGH INTELLIGENT AND CONNECTED TECHNOLOGY (CHONGQING) CO., LTD., Chongqing (CN)

(21) Appl. No.: 18/258,709

(22) PCT Filed: Dec. 30, 2021
(86) PCT No.: PCT/CN2021/142971

§ 371 Date: Jun. 21, 2023

(30) Foreign Application Priority Data
Dec. 30, 2020 (CN) 202011614436.1
Jul. 9, 2021 (CN) 202110777126.X

(51) Int. Cl. H04W 56/00; G08G 1/01; H04L 5/00; H04W 72/40

(52) U.S. Cl. CPC H04W 56/006; G08G 1/0116; H04L 5/0051; H04L 5/0053; H04W 72/40

(57) ABSTRACT

A position determination method, a synchronization method, a device, an apparatus and a terminal are provided. The position determination method for a first RSU includes transmitting a pilot signal and a positioning signaling. The positioning signaling includes an ID of the first RSU, a timing adjustment value of the first RSU and a timing offset value of the first RSU. The timing adjustment value is an adjustment amount for synchronization between the first RSU and a synchronization source when the positioning signaling is transmitted, and the timing offset value is a timing offset between the first RSU and a second RSU.

### CROSS-REFERENCE TO RELATED APPLICATION

This application claims priorities of the Chinese patent application No. 202011614436.1 filed in China on Dec. 30, 2020 and the Chinese patent application No. 202110777126.X filed in China on Jul. 9, 2021, which are incorporated herein by reference in their entireties.

### TECHNICAL FIELD

The present disclosure relates to the field of communication technology, in particular to a position determination method, a synchronization method, a position determination device, a synchronization device, an apparatus and a terminal.

### BACKGROUND

As a core of the Internet of Vehicles (IoV) technology, position information about a vehicle and relevant positioning technology not only relate to the security of the vehicle during the travelling, but also affect the security of the other traffic participants as well as the development of various IoV applications. Currently, a positioning mode in the IoV mainly depends on a Global Navigation Satellite System (GNSS). However, when the vehicle is in a complicated environment such as urban canyon, flyover, underground parking lot or tunnel, the vehicle may not receive a GNSS signal, so it is impossible to perform time synchronization in accordance with the GNSS signal. In order to position the vehicle in the case of no GNSS signal, a Road-Side-Unit (RSU) is mainly provided to communicate with an On-Board Unit (OBU) via a Long Term Evolution (LTE)-Vehicle to Everything (V2X) air interface. However, due to a distance between the RSUs, a propagation delay occurs for the signal during the transmission, so there is a timing drift between the RSUs. Hence, the synchronization accuracy of the entire IoV system is low, and thereby the positioning accuracy of the OBU is adversely affected.

### SUMMARY

An object of the present disclosure is to provide a position determination method, a synchronization method, a position determination device, a synchronization device, an apparatus and a terminal, so as to solve the problem in the related art where the synchronization accuracy of the entire IoV system is low and thereby the positioning accuracy of the OBU is adversely affected due to the timing drift between the RSUs.

In a first aspect, the present disclosure provides in some embodiments a position determination method for a first RSU, including transmitting a pilot signal and a positioning signaling. The positioning signaling includes an Identity (ID) of the first RSU, a timing adjustment value of the first RSU and a timing offset value of the first RSU. The timing adjustment value is an adjustment amount for synchronization between the first RSU and a synchronization source when the positioning signaling is transmitted, and the timing offset value is a timing offset between the first RSU and a second RSU.

In a second aspect, the present disclosure provides in some embodiments a positioning determination method for a mobile terminal, including: receiving pilot signals and positioning signaling transmitted by at least two RSUs, the positioning signaling including an ID of each RSU, a timing adjustment value of each RSU and a timing offset value of each RSU, the timing adjustment value being an adjustment amount for synchronization between each RSU and a synchronization source when the positioning signaling is transmitted, and the timing offset value comprising a timing offset between the at least two RSUs; and determining a position in accordance with the positioning signaling.

In a third aspect, the present disclosure provides in some embodiments a synchronization method for a second RSU, including: receiving a pilot signal and a positioning signaling transmitted by a first RSU, the positioning signaling including an ID of the first RSU, a timing adjustment value of the first RSU and a timing offset value of the first RSU, the timing adjustment value being an adjustment amount for synchronization between the first RSU and a synchronization source when the positioning signaling is transmitted, and the timing offset value being a timing offset between the first RSU and the second RSU; and performing synchronization with the first RSU in accordance with the positioning signaling.

In a fourth aspect, the present disclosure provides in some embodiments a position determination device for a first RSU, including a transmission module configured to transmit a pilot signal and a positioning signaling. The positioning signaling includes an ID of the first RSU, a timing adjustment value of the first RSU and a timing offset value of the first RSU. The timing adjustment value is an adjustment amount for synchronization between the first RSU and a synchronization source when the positioning signaling is transmitted, and the timing offset value is a timing offset between the first RSU and a second RSU.

In a fifth aspect, the present disclosure provides in some embodiments a position determination device for a mobile terminal, including: a first reception module configured to receive pilot signals and positioning signaling transmitted by at least two RSUs, the positioning signaling including an ID of each RSU, a timing adjustment value of each RSU and a timing offset value of each RSU, the timing adjustment value being an adjustment amount for synchronization between each RSU and a synchronization source when the positioning signaling is transmitted, and the timing offset value comprising a timing offset between the at least two RSUs; and a position calculation module configured to determine a position in accordance with the positioning signaling.

In a sixth aspect, the present disclosure provides in some embodiments a synchronization device for a second RSU, including: a second reception module configured to receive a pilot signal and a positioning signaling transmitted by a first RSU, the positioning signaling including an ID of the first RSU, a timing adjustment value of the first RSU and a timing offset value of the first RSU, the timing adjustment value being an adjustment amount for synchronization between the first RSU and a synchronization source when the positioning signaling is transmitted, and the timing offset value being a timing offset between the first RSU and the second RSU; and a synchronization processing module configured to perform synchronization with the first RSU in accordance with the positioning signaling.

In a seventh aspect, the present disclosure provides in some embodiments an RSU, which is a first RSU and includes a transceiver, a memory, a processor and a computer program stored in the memory and used to be executed by the processor. The processor is configured to execute the computer program so as to implement the step of the position determination method in the first aspect.

In an eighth aspect, the present disclosure provides in some embodiments a mobile terminal, including a transceiver, a memory, a processor and a computer program stored in the memory and used to be executed by the processor. The processor is configured to execute the computer program to implement steps of the position determination method in the second aspect.

In a ninth aspect, the present disclosure provides in some embodiments an RSU, which is a second RSU and includes a transceiver, a memory, a processor and a computer program stored in the memory and used to be executed by the processor. The processor is configured to execute the computer program to implement steps of the position determination method in the third aspect.

In a tenth aspect, the present disclosure provides in some embodiments a computer-readable storage medium storing therein a computer program. The computer program is used to be executed by a processor to implement the steps of the position determination method in the first aspect, or the second aspect or the third aspect.

The present disclosure has the following beneficial effects.

According to the embodiments of the present disclosure, the first RSU transmits the pilot signal and the positioning signaling. The positioning signaling includes the ID of the first RSU, the timing adjustment value of the first RSU and the timing offset value of the first RSU. The timing adjustment value is an adjustment amount for synchronization between the first RSU and the synchronization source when the positioning signaling is transmitted, and the timing offset value is a timing offset between the first RSU and the second RSU. The mobile terminal, e.g., an OBU, may determine the position in accordance with the pilot signal and the positioning signaling, and the other RSU may also perform the synchronization with the first RSU in accordance with the positioning signaling. As a result, it is able to eliminate a timing drift between the RSUs due to a propagation distance between the RSUs, thereby to improve the synchronization accuracy of the entire IoV system, and ensure the positioning accuracy of the OBU.

### BRIEF DESCRIPTION OF THE DRAWINGS

FIG. 1 is a flow chart of a positioning determination method according to an embodiment of the present disclosure;

FIG. 2 is a schematic view showing the timing adjustment in a gap between time periods where positioning signaling is transmitted according to an embodiment of the present disclosure;

FIG. 3 is another flow chart of the position determination method according to an embodiment of the present disclosure:

FIG. 4 is a schematic view showing the transmission of the positioning signaling according to an embodiment of the present disclosure:

FIG. 5 is a schematic view showing a positioning process according to an embodiment of the present disclosure:

FIG. 6 is a schematic view showing an application scenario according to an embodiment of the present disclosure;

FIG. 7 is a framework diagram of an LTE-based IoV radio communication technology:

FIG. 8 is a flow chart of a synchronization method according to an embodiment of the present disclosure:

FIG. 9 is another schematic view showing the application scenario according to an embodiment of the present disclosure:

FIG. 10 is yet another schematic view showing the application scenario according to an embodiment of the present disclosure:

FIG. 11 is a block diagram of a position determination device according to an embodiment of the present disclosure:

FIG. 12 is another block diagram of the position determination device according to an embodiment of the present disclosure:

FIG. 13 is a block diagram of a synchronization device according to an embodiment of the present disclosure;

FIG. 14 is a schematic view showing a hardware structure of an RSU according to an embodiment of the present disclosure:

FIG. 15 is a schematic view showing a hardware structure of a mobile terminal according to an embodiment of the present disclosure; and

FIG. 16 is another schematic view showing the hardware structure of the RSU according to an embodiment of the present disclosure.

### DETAILED DESCRIPTION

In order to make the objects, the technical solutions and the advantages of the present disclosure more apparent, the present disclosure will be described hereinafter in conjunction with the drawings and embodiments. In the following description, specific details of configurations and assemblies are merely provided to facilitate the understanding of the present disclosure. It should be appreciated that, a person skilled in the art may make further modifications and alternations without departing from the spirit of the present disclosure. In addition, for clarification and conciseness, any known function and structure will not be described hereinafter.

It should be appreciated that, such expressions as “an embodiment” intend to indicate that the features, structures or characteristics are contained in at least one embodiment of the present disclosure, rather than necessarily referring to a same embodiment. In addition, the features, structures or characteristics may be combined in any embodiment or embodiments in an appropriate manner.

It should be appreciated that, the following serial numbers do not refer to the order of the steps. Actually, the order shall be determined in accordance with functions and internal logic of the steps, but shall not be construed as limiting the implementation in any form.

In addition, the terms “system” and “network” may be replaced with each other herein.

It should be further appreciated that, the expression “B corresponding to A” means that B is related to A and may be determined in accordance with A. It should be further appreciated that, in the case that B is determined in accordance with A, it means that B may be determined in accordance with A and/or any other information.

In the embodiments of the present disclosure, an access network may be in various forms, and it may include a macro base station, a pico base station, a Node B (for 3^{rd}-Generation (3G) mobile base station), an evolved Node B (eNB), a femto eNB (or home eNode B, home eNB or HeNB), a relay, an access point, a Remote Radio Unit (RRU), or a Remote Radio Head (RRH). A UE may be a mobile phone (or cell phone), or any other device capable of transmitting or receiving a radio signal, e.g., a terminal, a Personal Digital Assistant (PDA), a wireless modem, a wireless communication device, a handheld device, a laptop computer, a cordless telephone, a Wireless Local Loop (WLL) station, a Customer Premise Equipment (CPE) or an Mifi capable of converting a mobile signal into a Wireless Fidelity (WiFi) signal, an intelligent household electrical appliance, or any other device capable of spontaneously communicating with a mobile communication network.

To be specific, an object of the present disclosure is to provide a position determination method, a synchronization method, a position determination device, a synchronization device, an apparatus and a terminal, so as to solve the problem in the related art where the synchronization accuracy of the entire IoV system is low and thereby the positioning accuracy of the OBU is adversely affected due to a positioning drift between the RSUs.

### First Embodiment

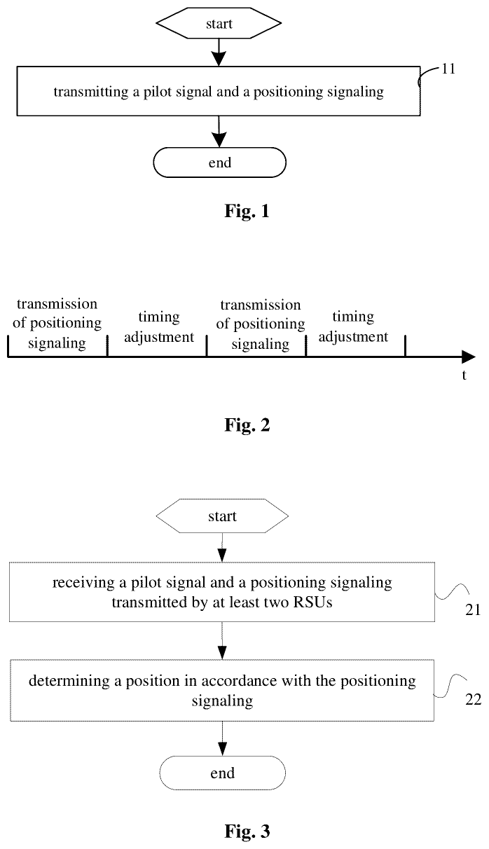

As shown in FIG. 1, the present disclosure provides in this embodiment a position determination method for a first RSU, which specifically includes Step 11 of transmitting a pilot signal and a positioning signaling. The positioning signaling includes an ID of the first RSU, a timing adjustment value of the first RSU and a timing offset value of the first RSU. The timing adjustment value is an adjustment amount for synchronization between the first RSU and a synchronization source when the positioning signaling is transmitted, and the timing offset value is a timing offset between the first RSU and a second RSU.

In this step, the transmitting the pilot signal and the positioning signaling includes transmitting the positioning signaling through a Physical Sidelink Control Channel (PSCCH), or through the PSCCH and a Physical Sidelink Shared Channel (PSSCH), or through the PSSCH.

The pilot signal is a DeModulation Reference Signal (DMRS).

It should be appreciated that, in an LTE-V2X system and an NR-V2X system, the DMRS is transmitted while transmitting the PSCCH so as to detect the PSCCH at a receiving side, and the DMRS is transmitted while transmitting the PSSCH so as to detect the PSSCH at the receiving side.

It should be further appreciated that, for the timing adjustment, a first timing adjustment value is used by the first RSU for adjustment in a gap between time periods where the positioning signaling is transmitted. FIG. 2 shows a time sequence of the transmission of the positioning signaling and the timing adjustment.

In this embodiment of the present disclosure, the RSU transmits the pilot signal and the positioning signaling, so that a mobile terminal, e.g., an OBU or a Vulnerable Road User (VRU), receives the positioning signaling and the pilot signal transmitted by at least one RSU, and determines an real timing offset between the RSUs in accordance with the timing adjustment value and the timing offset value in the positioning signaling, so as to achieve the positioning accurately in accordance with the real timing offset between the RSUs. As a result, it is able to prevent the occurrence of a timing drift between the RSUs due to a propagation delay of the signal caused by a propagation distance between the RSUs, thereby to increase the synchronization accuracy of the entire IoV system, and prevent the positioning accuracy of the OBU from being adversely affected.

In a possible embodiment of the present disclosure, the transmitting the positioning signaling through the PSCCH and the PSSCH includes: transmitting a first portion of the positioning signaling through the PSCCH; and transmitting a second portion of the positioning signaling through the PSSCH. The first portion is used to indicate whether the positioning signaling is carried on the PSCCH. The second portion of the positioning signaling is carried on the PSSCH indicated by the PSCCH, and the second portion is used to indicate the ID of the first RSU, the timing adjustment value of the first RSU, and the timing offset value of the first RSU.

To be specific, the first portion is carried through Sidelink Control Information (SCI).

In the embodiments of the present disclosure, the positioning signaling includes two portions, the first portion is carried on the PSCCH, and the second portion is carried on the PSSCH. As specified in the industry standard YD/T3755-2020 “Technical requirement of vehicle terminal for LTE-based vehicular communication”, an SCI format 1 is adopted by the SCI, and currently at least seven bits serve as filled bits. As an implementation mode, the first portion of the positioning signaling is carried by last N bits in the SCI in the PSCCH, i.e., aᵢ, aᵢ₊₁, . . . , and a_{i+N-1}, so as to indicate a current subframe number and indicate whether the signaling is the positioning signaling, wherein a=Σⱼ₌₁^{i+N-1}aⱼ×2^{31-j}, where aⱼ is a value of a j^{th} bit, and i=31−N+1. When a value of a is greater than 0, it means that the first portion of the positioning signaling is carried on the PSCCH, and a message about the second portion is carried on the PSSCH indicated by the PSCCH.

When the positioning signaling is transmitted through the PSSCH, optionally, the positioning signaling may be carried through a Medium Access Control (MAC) Protocol Data Unit (PDU) or carried through an application layer. When the MAC PDU is adopted, the PSSCH positioning signaling is carried through a channel in 10101 to 11011 reserved in a Logical Channel Identity (LCID) field in a Sidelink Shared Channel (SL-SCH). When the positioning signaling is carried through the application layer, as shown in FIG. 7, a transmitting end (terminal 1) may carry the positioning signaling in an application layer message, and a receiving end (terminal 2) may parse the positioning signaling at the application layer.

For example, a format of the second portion of the positioning signaling transmitted by the first RSU is shown in Table 1.

TABLE 1

| | | |
|---|---|---|
| ID of the first | Timing adjustment | Timing offset |
| RSU | value of the | between the first |
| | first RSU | RSU and the |
| | | second RSU |

The timing offset is a timing offset of the second RSU relative to a time of a current RSU (the first RSU) measured by the first RSU in accordance with the positioning signaling that is transmitted by the neighboring second RSU and detected by the first RSU.

In a possible embodiment of the present disclosure, the positioning signaling further includes position information about the first RSU, the position information about the first RSU is indicated through the second portion.

For example, a format of the positioning signaling transmitted by the first RSU is shown in Table 2.

TABLE 2

| | | | |
|---|---|---|---|
| ID of the first | Timing adjustment | Timing offset | Position |
| RSU | value of the | between the first | information |
| | first RSU | RSU and the | about the |
| | | second RSU | first RSU |

The position information about the first RSU is M-dimensional position information about the first RSU for positioning a vehicle, where 1≤M≤3.

It should be appreciated that, Table 1 and Table 2 show respective two formats of the positioning signaling. When the mobile terminal, e.g., an OBU or a VRU, is incapable of obtaining the position information about the RSU through an electronic map or the like, the positioning signaling is in the format in Table 2, and when the mobile terminal, e.g., the OBU or the VRU, is capable of obtaining the position information about the RSU through the electronic map or the like, the position signaling is in the format in Table 1.

The second RSU is one or more of N neighboring RSUs detected by the first RSU. The timing offset between the first RSU and the second RSU is a timing offset of the second RSU relative to the current RSU (the first RSU) measured by the first RSU in accordance with the positioning signaling received from the second RSU.

It should be appreciated that, when the positioning signaling is transmitted through the PSSCH, the positioning signaling further includes the position information about the first RSU. The position information about the first RSU is M-dimensional position information about the first RSU for positioning the vehicle, where 1≤M≤3.

### Second Embodiment

As shown in FIG. 8, the present disclosure provides in this embodiment a position determination method for a mobile terminal. The mobile terminal includes, but not limited to, an OBU or a VRU. The position determination method specifically includes the following steps.
Step 21: receiving pilot signals and positioning signaling transmitted by at least two RSUs. The positioning signaling includes an ID of each RSU, a timing adjustment value of each RSU and a timing offset value of each RSU. The timing adjustment value is an adjustment amount for synchronization between each RSU and a synchronization source when the positioning signaling is transmitted, and the timing offset value includes a timing offset between the at least two RSUs.

In this step, the receiving the pilot signal and the positioning signaling transmitted by the at least two RSUs includes: receiving the positioning signaling transmitted by the at least two RSUs through a PSCCH, or receiving the positioning signaling transmitted by the at least two RSUs through the PSCCH and a PSSCH, or receiving the positioning signaling transmitted by the at least two RSUs through the PSSCH. The pilot signal is a DMRS.

It should be appreciated that, in an LTE-V2X system and an NR-V2X system, the DMRS is transmitted while transmitting the PSCCH so as to detect the PSCCH at a receiving side, and the DMRS is transmitted while transmitting the PSSCH so as to detect the PSSCH at the receiving side.

It should be further appreciated that, for the timing adjustment, a first timing adjustment value is used by the first RSU for adjustment in a gap between time periods where the positioning signaling is transmitted. FIG. 2 shows a time sequence of the transmission of the positioning signaling and the timing adjustment.

When the positioning signaling transmitted by the at least two RSUs through the PSSCH is received, the positioning signaling is carried through an MAC PDU or carried through an application layer. When the MAC PDU is adopted, the PSSCH positioning signaling is carried through a channel in 10101 to 11011 reserved in an LCID field in an SL-SCH. When the positioning signaling is carried through the application layer, as shown in FIG. 7, a transmitting end (terminal 1) carries the positioning signaling in an application layer message, and a receiving end (terminal 2) parses the positioning signaling at the application layer.
Step 22: determining a position in accordance with the positioning signaling.

In this step, a real offset value between the RSUs is calculated in accordance with the timing adjustment values of the at least two RSUs and the timing offset values of the at least two RSUs, and then the position is determined in accordance with the real offset value between the RSUs.

To be specific, the calculating the real offset value between the RSUs in accordance with the timing adjustment values of the at least two RSUs and the timing offset values of the at least two RSUs includes: calculating the real offset value between the two RSUs through Rt_{xy}=(Ta_{xy}−Ta_{yx}−Tdₓ+Td_{y}−Δt_{xy}+Δt_{yx})/2, where x and y are the two RSUs, Rt_{xy} is the actual offset value between x and y, Ta_{xy} is a timing offset value relative to y determined by x, Ta_{yx} is a timing offset value that is relative to x and determined by y, Tdₓ is a timing adjustment value of x, Td_{y} is a timing adjustment value of y, Δt_{xy} is a timing measurement error determined by x, and Δt_{yx} is a timing measurement error determined by y.

For example, as shown in FIG. 4, a propagation distance between RSUx and RSUy is L_{xy}, timing offsets of RSUx and RSUy relative to a reference clock are T_{x,i-1} and T_{y,i-1} respectively at a time point i−1, and a relative timing offset measured by RSUy through receiving the positioning signaling from RSUx is Ta_{yx,i-1}. After the timing adjustment Td_{x,i-1} and Td_{y,i-1}, timing offsets of RSUx and RSUy relative to the reference clock are T_{x,i} and T_{y,i} respectively at a time point i. RSUy transmits the positioning signaling, and a relative timing offset measured by RSUx through receiving the positioning signaling from RSUy is Ta_{xy,i}. At this time,

$${Ta}_{yx , i - 1} = {T}_{y , i - 1} - {T}_{x , i - 1} + \frac{{L}_{xy}}{c} + Δ {t}_{yx , i - 1} , and \qquad ( 1 )$$

$${Ta}_{xy , i} = {T}_{x , i} - {T}_{y , i} + \frac{{L}_{xy}}{c} + Δ {t}_{xy , i} , \qquad ( 2 )$$

where Δt_{yx,i-1} and Δt_{xy,i} are the timing measurement errors of RSUy and RSUx respectively, and c is velocity of light.

In actual use, RSUx and RSUy are stationary relative to each other, so a value of Ta_{xy,i} actually approaches to a value of Ta_{yx,i-1}. Because T_{x,i}=(T_{x,i-1}−Td_{x,i-1}) and T_{y,i}=(T_{y,i-1}−Td_{y,i-1}), T_{x,i-1}=T_{x,i}+Td_{x,i-1} and T_{y,i-1}=T_{y,i}+Td_{y,i-1} are substituted into the above equation (1), and then the above equation (1) is subtracted from the above equation (2) to obtain the following equation (3) for calculating the real offset between T_{x,i} and T_{y,i}:

$$\begin{matrix}{Rt}_{xy , i} = {T}_{x , i} - {T}_{y , i} \\ = ( {Ta}_{xy , i} - {Ta}_{yx , i - 1} - {Td}_{x , i - 1} + {Td}_{y , i - 1} - Δ {t}_{xy , i} + Δ {t}_{yx , i - 1} ) / 2\end{matrix} .$$

Based on the above equation (3), it is able to eliminate the influence of the propagation distance L_{xy} between the RSUs on the timing offset. In this way, the OBU may determine the real timing offset between the RSUs in accordance with the timing offset value and the timing adjustment value in the positioning signaling from the RSU, so as to achieve the positioning in a more accurate manner.

In this embodiment of the present disclosure, the OBU receives the timing offset value and the timing adjustment value of each RSU in the positioning signaling transmitted by the RSU, and determines the real timing offset between the RSUs, so as to achieve the positioning in a more accurate manner. As a result, it is able to prevent the occurrence of a timing drift between the RSUs due to a propagation delay of the signal caused by a propagation distance between the RSUs, thereby to increase the synchronization accuracy of the entire IoV system, and prevent the positioning accuracy of the OBU from being adversely affected.

In a possible embodiment of the present disclosure, the receiving the positioning signaling transmitted by the at least two RSUs through the PSCCH and the PSSCH includes: receiving a first portion of the positioning signaling transmitted by the at least two RSUs through the PSCCH; and receiving a second portion of the positioning signaling transmitted by the at least two RSUs through the PSSCH. The first portion is used to indicate whether the positioning signaling is carried on the PSCCH. The second portion of the positioning signaling is carried on the PSSCH indicated by the PSCCH, and the second portion is used to indicate the ID of each RSU, the timing adjustment value of each RSU, and the timing offset value of each RSU.

To be specific, the first portion is carried through SCI.

In the embodiments of the present disclosure, the positioning signaling includes two portions, the first portion is carried on the PSCCH, and the second portion is carried on the PSSCH. As specified in the industry standard YD/T3755-2020 “Technical requirement of vehicle terminal for LTE-based vehicular communication”, an SCI format 1 is adopted by the SCI, and currently at least seven bits serve as filled bits. As an implementation mode, the first portion of the positioning signaling is carried by last N bits in the SCI in the PSCCH, i.e., aᵢ, aᵢ₊₁, . . . , and a_{i+N-1}, so as to indicate a current subframe number and indicate whether the signaling is the positioning signaling. a=Σⱼ₌₁^{i+N-1}aⱼ×2^{31-j}, where aⱼ is a value of a j^{th} bit, and i=31−N+1. When a value of a is greater than 0, it means that the first portion of the positioning signaling is carried on the PSCCH, and a message about the second portion is carried on the PSSCH indicated by the PSCCH.

For example, a format of the second portion of the positioning signaling transmitted by the first RSU is shown as follows:

| | | |
|---|---|---|
| ID of the first | Timing adjustment | Timing offset |
| RSU | value of the | between the first |
| | first RSU | RSU and the |
| | | second RSU |

The timing offset is a timing offset of the second RSU relative to a time of a current RSU (the first RSU) measured by the first RSU in accordance with the positioning signaling that is transmitted by the neighboring second RSU and detected by the first RSU.

In a possible embodiment of the present disclosure, the positioning signaling further includes position information about the first RSU, the position information about the first RSU is indicated through the second portion.

For example, a format of the positioning signaling transmitted by the first RSU is shown as follows:

| | | | |
|---|---|---|---|
| ID of the first | Timing adjustment | Timing offset | Position |
| RSU | value of the | between the first | information |
| | first RSU | RSU and the | about the |
| | | second RSU | first RSU |

The position information about the first RSU is M-dimensional position information about the first RSU for positioning a vehicle, where 1≤M≤3.

The second RSU is one or more of N neighboring RSUs detected by the first RSU. The timing offset between the first RSU and the second RSU is a timing offset of the second RSU relative to the current RSU (the first RSU) measured by the first RSU in accordance with the positioning signaling received from the second RSU.

In a possible embodiment of the present disclosure, in the case that the positioning signaling transmitted by the first RSU does not include the position information about the first RSU, the position determination method further includes determining position information about the at least two RSUs.

In a possible embodiment of the present disclosure, when receiving the positioning signaling transmitted by the at least two RSUs through the PSSCH, the positioning signaling further includes position information about the RSU. The position information about the RSU is M-dimensional position information about the RSU for positioning a vehicle, where 1≤M≤3.

In Step 22, the determining the position in accordance with the positioning signaling includes: calculating a real offset value between the RSUs in accordance with the timing adjustment values of the at least two RSUs and the timing offset values of the at least two RSUs; and calculating the position of the mobile terminal in accordance with the position information about the at least two RSUs and the real offset value.

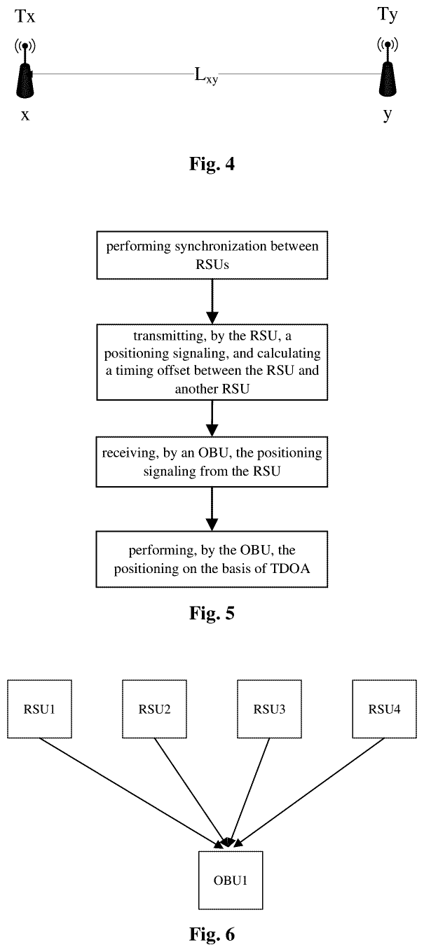

For example, FIG. 5 shows a positioning process of the mobile terminal. At first, synchronization is performed between the RSUs in a wired or wireless manner (it should be appreciated that, in a synchronization state, an asynchronization problem still occurs between the RSUs due to the timing drift). After the synchronization, the RSU transmits the positioning signaling, receives the positioning signaling from the other RSU, and calculates the timing offset relative to the other RSU. The OBU receives the positioning signaling from the plurality of RSUs, and determines its position on the basis of Time Difference of Arrival (TDOA).

It is presumed that the OBU has received the positioning signaling from n RSUs, and positions of the n RSUs are (xᵢ, yᵢ, zᵢ), where i=1, 2, . . . , n; and the timing offset between the time when the OBU receives from the RSU the positioning signaling and the time when each of the RSUs transmits the positioning signaling is Δtᵢ, where i=1, 2, . . . , n. When a time of an RSUj is taken as a positioning time reference, the position (x₀, y₀, z₀) of the OBU is calculated through c(Δtᵢ+ΔRtᵢⱼ)=\sqrt{(xᵢ−x₀)²+(yᵢ−y₀)²+(zᵢ−z₀)²}+c×Δt, where Δt represents a clock offset between the OBU and the RSUj, c represents the velocity of light, and ΔRtᵢⱼ represents a real offset between the RSUi and the RSUj.

For example, in an application scenario as shown in FIG. 6, it is presumed that RSU1, RSU2, RSU3 and RSU4 have already entered the synchronization state (it should be appreciated that, in a synchronization state, an asynchronization problem still occurs between the RSUs due to the timing drift), and OBU1 has obtained three-dimensional coordinates (xᵢ, yᵢ, zᵢ) of each RSU through the positioning signaling or any other method, where i=1, 2, 3, 4. A clock offset between OBU1 and RSU1 is Δt, and an offset between a time where the positioning signaling is received by the OBU from the RSU and a time when the positioning signaling is transmitted by the RSU is Δtᵢ, where i=1, 2, 3, 4. When the time of RSU1 is taken as a positioning time reference, the position (x₀, y₀, z₀) of OBU1 and Δt are obtained through following equations:

$$c Δ {t}_{1} = \sqrt{{( {x}_{1} - {x}_{0} )}^{2} + {( {y}_{1} - {y}_{0} )}^{2} + {( {z}_{1} - {z}_{0} )}^{2}} + c \times Δ t , \\ c ( Δ {t}_{2} + Δ {Rt}_{21} ) = \sqrt{{( {x}_{2} - {x}_{0} )}^{2} + {( {y}_{2} - {y}_{0} )}^{2} + {( {z}_{2} - {z}_{0} )}^{2}} + c \times Δ t , \\ c ( Δ {t}_{3} + Δ {Rt}_{31} ) = \sqrt{{( {x}_{3} - {x}_{0} )}^{2} + {( {y}_{3} - {y}_{0} )}^{2} + {( {z}_{3} - {z}_{0} )}^{2}} + c \times Δ t , \\ c ( Δ {t}_{4} + Δ {Rt}_{41} ) = \sqrt{{( {x}_{4} - {x}_{0} )}^{2} + {( {y}_{4} - {y}_{0} )}^{2} + {( {z}_{4} - {z}_{0} )}^{2}} + c \times Δ t ,$$

where c represents velocity of light.

### Third Embodiment

As shown in FIG. 8, the present disclosure provides in this embodiment a synchronization method for a second RSU, which specifically includes the following steps.
Step 31: receiving a pilot signal and a positioning signaling transmitted by a first RSU. The positioning signaling includes an ID of the first RSU, a timing adjustment value of the first RSU and a timing offset value of the first RSU, the timing adjustment value is an adjustment amount for synchronization between the first RSU and a synchronization source when the positioning signaling is transmitted, and the timing offset value is a timing offset between the first RSU and the second RSU.

In this step, the receiving the pilot signal and the positioning signaling transmitted by the first RSU includes receiving the positioning signaling transmitted by the first RSU through a PSCCH, or receiving the positioning signaling transmitted by the first RSU through the PSCCH and a PSSCH. The pilot signal is a DMRS.

It should be appreciated that, in an LTE-V2X system and an NR-V2X system, the DMRS is transmitted while transmitting the PSCCH so as to detect the PSCCH at a receiving side, and the DMRS is transmitted while transmitting the PSSCH so as to detect the PSSCH at the receiving side.

It should be further appreciated that, for the timing adjustment, a first timing adjustment value is used by the first RSU for adjustment in a gap between time periods where the positioning signaling is transmitted. FIG. 2 shows a time sequence of the transmission of the positioning signaling and the timing adjustment.

It should be further appreciated that, when T is a relative offset value between the RSU and a reference time and Td is the timing adjustment when the positioning signaling is transmitted, an offset value between the RSU and the reference time is T+Td during the transmission of the positioning signaling.
Step 32: performing synchronization with the first RSU in accordance with the positioning signaling.

In this embodiment of the present disclosure, the positioning signaling is received from the first RSU, and a real timing offset between the first RSU and the second RSU is obtained in accordance with the timing offset value and the timing adjustment value in the positioning signaling, so as to achieve the synchronization between the RSUs in a more accurate manner, and achieve the synchronized collaboration between the RSUs even in the case that it is impossible to perform the time synchronization through a satellite signal and it is impossible to meet the requirement on high-accuracy time synchronization for a long time period when the accuracy of an internal clock of an IoV device is relatively low. As a result, it is able to prevent the occurrence of a timing drift between the RSUs due to a propagation delay of the signal caused by a propagation distance between the RSUs, thereby to increase the synchronization accuracy of the entire IoV system, and prevent the positioning accuracy of the OBU from being adversely affected.

It should be appreciated that, due to the propagation distance between the RSUs, the propagation delay occurs for the synchronization signal and the timing drift exists between the RSUs. In addition, a maximum transmission distance of the synchronization signal is halved. However, in this embodiment of the present disclosure, the timing offset values and the timing adjustment values of the first RSU and the second RSU are transmitted through the positioning signaling, so it is able to eliminate the influence of the propagation distance on the timing, and improve the synchronization accuracy between the RSUs, thereby to improve the positioning accuracy of the OBU.

In a possible embodiment of the present disclosure, Step 32 of performing the synchronization with the first RSU in accordance with the positioning signaling includes: determining a second timing adjustment value of the second RSU relative to the first RSU in accordance with the positioning signaling transmitted by the first RSU: determining a second timing adjustment value of the second RSU when the positioning signaling is received: calculating a real offset value of the second RSU relative to the first RSU in accordance with the first timing offset value, the first timing adjustment value, the second timing adjustment value and the second timing offset value; and performing the synchronization between the second RSU and the first RSU in accordance with the real offset value.

To be specific, the calculating the real offset value of the second RSU relative to the first RSU in accordance with the first timing offset value, the first timing adjustment value, the second timing adjustment value and the second timing offset value includes calculating the real offset value of the second RSU relative to the first RSU through Rt_{xy}=(Ta_{xy}−Ta_{yx}−Tdₓ+Td_{y}+Δt_{yx}−Δt_{xy})/2, where x is the second RSU, y is the first RSU, Rt_{xy} is the real offset value of the second RSU relative to the first RSU, Ta_{yx} is the first timing offset value, Ta_{xy} is the second timing offset value, Tdₓ is the second timing adjustment value, Td_{y} is the first timing adjustment value, Δt_{yx} is a timing measurement error determined by the first RSU, and Δt_{xy} is a timing measurement error determined by the second RSU.

For example, as shown in FIG. 4, as shown in FIG. 4, a propagation distance between RSUx and RSUy is L_{xy}, timing offsets of RSUx and RSUy relative to a reference clock are T_{x,i-1} and T_{y,i-1} respectively at a time point i−1, and a relative timing offset measured by RSUy through receiving the positioning signaling from RSUx is Ta_{yx,i-1}. After the timing adjustment Td_{x,i-1} and Td_{y,i-1}, timing offsets of RSUx and RSUy relative to the reference clock are T_{x,i} and T_{y,i} respectively at a time point i. RSUy transmits the positioning signaling, and a relative timing offset measured by RSUx through receiving the positioning signaling from RSUy is Ta_{xy,i}. At this time,

$${Ta}_{yx , i - 1} = {T}_{y , i - 1} - {T}_{x , i - 1} + \frac{{L}_{xy}}{c} + Δ {t}_{yx , i - 1} , and \qquad ( 1 )$$

$${Ta}_{xy , i} = {T}_{x , i} - {T}_{y , i} + \frac{{L}_{xy}}{c} + Δ {t}_{xy , i} , \qquad ( 2 )$$

where Δt_{yx,i-1} and Δt_{xy,i} are the timing measurement errors of RSUy and RSUx respectively, and c is velocity of light.

In actual use, RSUx and RSUy are stationary relative to each other, so a value of Ta_{xy,i} actually approaches to a value of Ta_{yx,i-1}. Because T_{x,i}=(T_{x,i-1}−Td_{x,i-1}) and T_{y,i}=(T_{y,i-1}−Td_{y,i-1}), T_{x,i-1}=T_{x,i}+Td_{x,i-1} and T_{y,i}-1=T_{y,i}+Td_{y,i-1} are substituted into the above equation (1), and then the above equation (1) is subtracted from the above equation (2) to obtain the following equation (3) for calculating the real offset between T_{x,i} and T_{y,i}:

$$\begin{matrix}{Rt}_{xy , i} = {T}_{x , i} - {T}_{y , i} \\ = ( {Ta}_{xy , i} - {Ta}_{yx , i - 1} - {Td}_{x , i - 1} + {Td}_{y , i - 1} - Δ {t}_{xy , i} + Δ {t}_{yx , i - 1} ) / 2\end{matrix} .$$

Based on the above equation (3), it is able to eliminate the influence of the propagation distance L_{xy} between the RSUs on the timing offset. In this way, the OBU may determine the real timing offset between the RSUs in accordance with the timing offset value and the timing adjustment value in the positioning signaling from the RSU, so as to eliminate the influence of the low synchronization accuracy between the RSUs on the positioning accuracy, thereby to achieve the positioning in a more accurate manner.

In this embodiment of the present disclosure, it is able to increase the synchronization accuracy between the RSUs in accordance with the timing offset values of the RSUs and the timing adjustment values of the RSUs in the positioning signaling transmitted by each of the RSUs, thereby to improve the synchronization accuracy of the entire IoV system, and position the OBU in a more accurate manner.

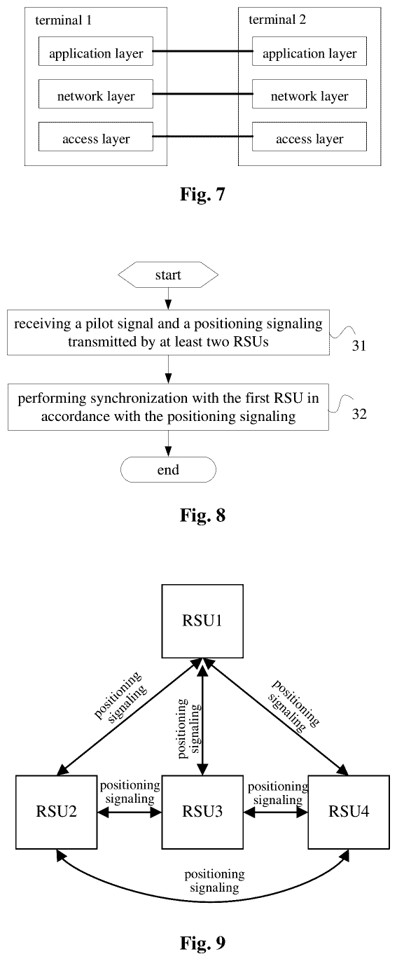

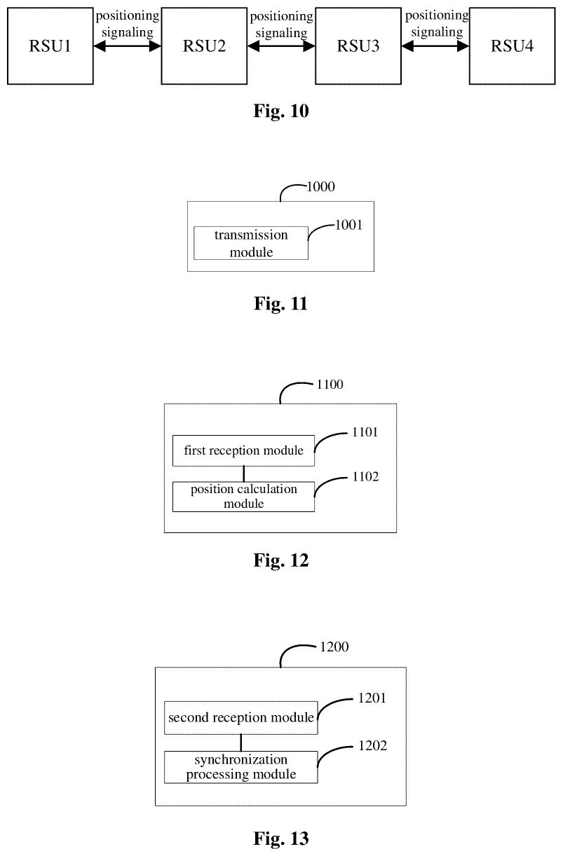

The calculation of the real timing offset between the RSUs will be described hereinafter in conjunction with specific application scenarios in FIGS. 9 and 10.

For example, system parameters of such IoV devices as RSU and OBU are configured as follows: a system bandwidth of 20 MHz, a duplex mode that supports half-duplex, a subcarrier spacing of 15 kHz, a Cyclic Prefix (CP) length of 4.687 μs (5.208 μs (symbol 0)), a modulation mode of Quadrature Phase Shift Keying (QPSK), and maximum transmission power of 23 dBm.

FIG. 9 shows an IoV application scenario where 4 RSUs are included, and the respective positioning signaling is transmitted by each of RSU1, RSU2, RSU3 and RSU4. When the positioning signaling is transmitted by each RSU for the first time, it is impossible for the RSU to calculate a timing offset relative to the other RSU, and at this time, the timing offset may be set as 0. Each of RSU1 to RSU4 receives the positioning signaling from the other RSU, calculates a timing offset Taᵢⱼ of the other RSU relative to a time of the current RSU (where i=1, 2, 3, 4, j=1, 2, 3, 4, and i+j), and transmits the timing offset in the positioning signaling subsequently. The real timing offset Rtᵢⱼ between the RSUs is calculated in accordance with the timing offset carried in the positioning signaling through Rtᵢⱼ=Tᵢ−Tⱼ≈(Taᵢⱼ−Taⱼᵢ−Tdᵢ+Tdⱼ+Δtⱼᵢ−Δtᵢⱼ)/2, where Tᵢ is an offset between RSUi and a reference time, Tⱼ is an offset between RSUj and the reference time, Taᵢⱼ is a timing offset of RSUi relative to RSUj measured by RSUi, Taj is a timing offset of RSUj relative to RSUi measured by RSUj, Tdᵢ is a timing adjustment value of RSUi when the positioning signaling is transmitted, Td=_{j,} is a timing adjustment value of RSUj when the positioning signaling is transmitted, Δtⱼᵢ is a timing measurement error of RSUj, and Δtᵢⱼ is a timing measurement error of RSUi.

For example, FIG. 10 shows a scenario where the RSU merely receives the positioning signaling from a neighboring RSU. RSU1 transmits the positioning signaling to, and receives the positioning signaling from, RSU2, so a real timing offset between RSU2 and RSU1 is calculated through Rt₂₁=T₂−T₁≈(Ta₂₁−Ta₁₂−Td₂+Td₁+Δt₁₂−Δt₂₁)/2.

Identically, a real timing offset between RSU3 and RSU2 and a real timing offset between RSU4 and RSU3 may be obtained. Hence, real timing offsets between RSU1 and each of RSU3 and RSU4 are calculated through: Rt₃₁=Rt₃₂+Rt₂₁; Rt₄₁=Rt₄₃+Rt₃₁.

Based on the above, the real timing offset between the RSUs may be obtained in accordance with the timing offset values of the RSUs and the timing adjustment values of the RSUs in the positioning signaling, so as to achieve the synchronization between the RSUs. In addition, it is also able to eliminate the influence of the propagation distance L_{xy} between the RSUs on the timing offset, thereby to improve the synchronization accuracy between the RSUs.

It should be appreciated that, in some embodiments of the present disclosure, when a calculation combination value of the timing adjustment value and the timing offset value is transmitted by the RSU in the positioning signaling, the OBU may also calculate the real offset value between the RSUs.

For example, in the case that a difference between the timing adjustment value and the timing offset value is transmitted by each RSU in the positioning signaling, the real timing offset between the RSUs is calculated through

$${Rt}_{xy} = ( {Ta}_{xy} - {T}^{′} {a}_{yx} - {Td}_{x} - Δ {t}_{xy} + Δ {t}_{yx} ) / 2 , \qquad ( 4 )$$

where T′a_{yx} is a difference between the first timing offset value and the first timing adjustment value, x is the second RSU, y is the first RSU, Rt_{xy} is a real timing offset between the first RSU and the second RSU, Ta_{xy} is the send timing offset value, Tdₓ is the second timing adjustment value, Δt_{yx} is the timing measurement error determined by the first RSU, and Δt_{xy} is the timing measurement error determined by the second RSU.

It should be appreciated that, the above equation (4) is derived as follows. Based on the above equation (2), T′a_{xy,i}=Ta_{xy,i}−Td_{x,i} and T′a_{yx,i}=Ta_{yx,i}−Td_{y,i},

$$\begin{matrix}{Ta}_{xy , i} = {T}_{x , i} - {T}_{y , i} + \frac{{L}_{xy}}{c} + Δ {t}_{xy , i} \\ = ( {T}_{x , i - 1} - {Td}_{x , i - 1} ) - ( {T}_{y , i - 1} - {Td}_{y , i - 1} ) + \frac{{L}_{xy}}{c} + Δ {t}_{xy , i} \\ = {T}_{x , i - 1} - {T}_{y , i - 1} + \frac{{L}_{xy}}{c} + Δ {t}_{xy , i} - {Td}_{x , i - 1} + {Td}_{y , i - 1} \\ = {Ta}_{xy , i - 1} - {Td}_{x , i - 1} + {Td}_{y , i - 1} \\ = {T}^{′} {a}_{xy , i} + {Td}_{y , i - 1}\end{matrix} , \\ \begin{matrix}so {Rt}_{xy , i} = {T}_{x , i} - {T}_{y , i} \\ = ( {Ta}_{xy , i} - {Ta}_{yx , i - 1} - {Td}_{x , i - 1} + {Td}_{y} - Δ {t}_{xy , i} + Δ {t}_{yx , i - 1} ) / 2 \\ = ( {Ta}_{xy , i} - {Td}_{x , i - 1} - {T}^{′} {a}_{xy , i} - Δ {t}_{xy , i} + Δ {t}_{yx , i - 1} ) / 2\end{matrix} .$$

Based on Rt_{xy,i}=(Ta_{xy,i}−Td_{x,i-1}−T′a_{xy,i}−Δt_{xy,i}+Δt_{yx,i-1})/2, when the difference between the timing offset value and the timing adjustment value, rather than the timing offset value and the timing adjustment value, is transmitted by the RSU, the OBU may still calculate the real timing offset between the first RSU and the second RSU in accordance with the positioning signaling transmitted by the first RSU and the second RSU.

### Fourth Embodiment

As shown in FIG. 11, the present disclosure provides in this embodiment a position determination device 1000 for a first RSU, which includes a transmission module 1001 configured to transmit a pilot signal and a positioning signaling. The positioning signaling includes an ID of the first RSU, a timing adjustment value of the first RSU and a timing offset value of the first RSU. The timing adjustment value is an adjustment amount for synchronization between the first RSU and a synchronization source when the positioning signaling is transmitted, and the timing offset value is a timing offset between the first RSU and a second RSU.

Optionally, the transmission module 1001 includes: a first transmission sub-module configured to transmit a DMRS through a PSCCH; or a second transmission sub-module configured to transmit the DMRS through the PSCCH and a PSCCH.

Optionally, the second transmission sub-module includes: a first transmission unit configured to transmit a first portion of the positioning signaling through the PSCCH; a second transmission unit configured to transmit a second portion of the positioning signaling through the PSSCH; and a third transmission unit configured to transmit the positioning signaling through the PSSCH. The first portion is used to indicate whether the positioning signaling is carried on the PSCCH, the second portion of the positioning signaling is carried on the PSSCH indicated by the PSCCH, and the second portion is used to indicate the ID of the first RSU, the timing adjustment value of the first RSU and the timing offset value of the first RSU.

Optionally, the positioning signaling further includes position information about the first RSU, and the position information about the first RSU is indicated through the second portion.

Optionally, the first portion is carried through SCI.

Optionally, when the positioning signaling is transmitted through the PSSCH, the positioning signaling further includes position information about the first RSU.

The position determination device in the fourth embodiment corresponds to the position determination method in the first embodiment, and the implementation of the position determination device may refer to that of the position determination method in the first embodiment with a same technical effect.

### Fifth Embodiment

As shown in FIG. 12, the present disclosure provides in this embodiment a position determination device 1100 for a mobile terminal, which includes: a first reception module 1101 configured to receive pilot signals and positioning signaling transmitted by at least two RSUs, the positioning signaling including an ID of each RSU, a timing adjustment value of each RSU and a timing offset value of each RSU, the timing adjustment value being an adjustment amount for synchronization between each RSU and a synchronization source when the positioning signaling is transmitted, and the timing offset value comprising a timing offset between the at least two RSUs; and a position calculation module 1102 configured to determine a position in accordance with the positioning signaling.

Optionally, the first reception module 1101 includes: a first reception sub-module configured to receive the positioning signaling transmitted by the at least two RSUs through a PSCCH: or a second reception sub-module configured to receive the positioning signaling transmitted by the at least two RSUs through the PSCCH and a PSSCH: or a third reception sub-module configured to receive the positioning signaling transmitted by the at least two RSUs through the PSSCH. The pilot signal is a DMRS.

Optionally, the second reception sub-module includes: a first reception unit configured to receive a first portion of the positioning signaling transmitted by the at least two RSUs through the PSCCH; and a second reception unit configured to receive a second portion of the positioning signaling transmitted by the at least two RSUs through the PSSCH. The first portion is used to indicate whether the positioning signaling is carried on the PSCCH, the second portion of the positioning signaling is carried on the PSSCH indicated by the PSCCH, and the second portion is used to indicate the ID of the RSU, the timing adjustment value of the RSU and the timing offset value of the RSU.

Optionally, the positioning signaling further includes position information about the RSU, and the position information about the RSU is indicated through the second portion.

Optionally, when the positioning signaling transmitted by the at least two RSUs through the PSSCH is received, the positioning signaling further includes position information about the RSU.

Optionally, the position determination device 1100 further includes a determination module configured to determine position information about the at least two RSUs. The position calculation module 1102 includes: a first calculation sub-module configured to calculate a real offset value between the RSUs in accordance with the timing adjustment values of the at least two RSUs and the timing offset values of the at least two RSUs; and a second calculation sub-module configured to calculate the position of the mobile terminal in accordance with the position information about the at least two RSUs and the real offset value.

Optionally, the first calculation sub-module includes a calculation unit configured to calculate the real offset value between two RSUs through Rt_{xy}=(Ta_{xy}−Ta_{yx}−Tdₓ+Td_{y}−Δt_{xy}+Δt_{yx})/2, where x and y represent the two RSUs respectively, Rt_{xy} represents a real offset between x and y, Ta_{xy} represents a timing offset value of x that is relative to y and determined by x, Ta_{yx} represents a timing offset value of y that is relative to x and determined by y, Tdₓ represents a timing adjustment value of x, Td_{y} represents a timing adjustment value of y, Δt_{xy} represents a timing measurement error determined by x, and Δt_{yx} represents a timing measurement error determined by y.

The position determination device in the fifth embodiment corresponds to the position determination method in the second embodiment, and the implementation of the position determination device may refer to that of the position determination method with a same technical effect.

### Sixth Embodiment

As shown in FIG. 13, the present disclosure provides in this embodiment a synchronization device 1200 for a second RSU, which includes: a second reception module 1201 configured to receive a pilot signal and a positioning signaling transmitted by a first RSU, the positioning signaling including an ID of the first RSU, a timing adjustment value of the first RSU and a timing offset value of the first RSU, the timing adjustment value being an adjustment amount for synchronization between the first RSU and a synchronization source when the positioning signaling is transmitted, and the timing offset value being a timing offset between the first RSU and the second RSU; and a synchronization processing module 1202 configured to perform synchronization with the first RSU in accordance with the positioning signaling.

Optionally, the synchronization processing module 1202 includes: a first processing sub-module configured to determine a second timing offset value of the second RSU relative to the first RSU in accordance with the positioning signaling transmitted by the first RSU: a second processing sub-module configured to determine a second timing adjustment value of the second RSU when the positioning signaling is received: a third processing sub-module configured to calculate a real offset value between the second RSU and the first RSU in accordance with the first timing offset value, the first timing adjustment value, the second timing adjustment value and the second timing offset value; and a fourth processing sub-module configured to perform the synchronization between the second RSU and the first RSU in accordance with the real offset value.

Optionally, the third processing sub-module includes a processing unit configured to calculate the real offset value between the second RSU and the first RSU through Rt_{xy}=(Ta_{xy}−Ta_{yx}−Tdₓ+Td_{y}+Δt_{yx}−Δt_{xy})/2, where x represents the second RSU, y represents the first RSU, Rt_{xy} represents a real offset between the second RSU and the first RSU, Ta_{xy} represents the first timing offset value, Ta_{yx} represents the second timing offset value, Tdₓ represents the second timing adjustment value, Td_{y} represents the first timing adjustment value, Δt_{xy} represents a timing measurement error determined by the first RSU, and Δt_{yx} represents a timing measurement error determined by the second RSU.

The synchronization device in the sixth embodiment corresponds to the synchronization method in the third embodiment, and the implementation of the position determination device may refer to that of the synchronization method with a same technical effect.

### Seventh Embodiment

In order to achieve the above-mentioned purposes in a better manner, as shown in FIG. 14, the present disclosure further provides in this embodiment an RSU, which is a first RSU and includes a processor 1300, and a memory 1320 coupled to the processor 1300 via a bus interface and configured to store therein programs and data for the operation of the processor 1300. The processor 1300 is configured to call and execute the programs and data in the memory 1320.

A transceiver 1310 is coupled to the bus interface, and configured to receive and transmit data under the control of the processor 1300. The processor 1300 is configured to read the programs in the memory 1320.

To be specific, the transceiver 1310 is configured to transmit a pilot signal and a positioning signaling. The positioning signaling includes an ID of the first RSU, a timing adjustment value of the first RSU and a timing offset value of the first RSU. The timing adjustment value is an adjustment amount for synchronization between the first RSU and a synchronization source when the positioning signaling is transmitted, and the timing offset value is a timing offset between the first RSU and a second RSU.

In FIG. 14, bus architecture may include a number of buses and bridges connected to each other, so as to connect various circuits for one or more processors 1300 and one or more memories 1320. In addition, as is known in the art, the bus architecture may be used to connect any other circuits, such as a circuit for a peripheral device, a circuit for a voltage stabilizer and a power management circuit. The bus interface may be provided, and the transceiver 1310 may consist of a plurality of elements, i.e., a transmitter and a receiver for communication with any other devices over a transmission medium. The processor 1300 may take charge of managing the bus architecture as well as general processings. The memory 1320 may store therein data for the operation of the processor 1300.

Optionally, the transceiver 1310 is specifically configured to transmit the positioning signaling through a PSCCH, or transmit the positioning signaling through the PSCCH and a PSSCH, or transmit the positioning signaling through the PSSCH. The pilot signal is a DMRS. When the positioning signaling is transmitted through the PSCCH and the PSSCH, the transceiver 1310 is specifically configured to transmit a first portion of the positioning signaling through the PSCCH, and transmit a second portion of the positioning signaling through the PSSCH. The first portion is used to indicate whether the positioning signaling is carried on the PSCCH, the second portion of the positioning signaling is carried on the PSSCH indicated by the PSCCH, the second portion is used to indicate the ID of the first RSU, the timing adjustment value of the first RSU and the timing offset value of the first RSU.

Optionally, the positioning signaling further includes position information about the first RSU, and the position information about the first RSU is indicated through the second portion.

Optionally, the first portion is carried through SCI.

Optionally, when the positioning signaling is transmitted through the PSSCH, the positioning signaling further includes position information about the first RSU.

According to the RSU in this embodiment of the present disclosure, the pilot signal and the positioning signaling are transmitted, so that a mobile terminal, e.g., an OBU or a VRU, receives the positioning signaling and the pilot signal from at least one RSU, and determines a real timing offset between the RSUs in accordance with the timing adjustment value and the timing offset value in the positioning signaling, so as to achieve the positioning accurately in accordance with the real timing offset. As a result, it is able to prevent the occurrence of a timing drift between the RSUs due to a propagation delay of the signal caused by a propagation distance between the RSUs, thereby to increase the synchronization accuracy of the entire IoV system, and prevent the positioning accuracy of the OBU from being adversely affected.

It should be appreciated that, all of, or parts of, the steps may be implemented through hardware, or implemented through relevant hardware under the control of a computer program. The computer program may include instructions for executing parts of, or all of, the steps of the method, and it may be stored in a readable storage medium in any form.

### Eighth Embodiment

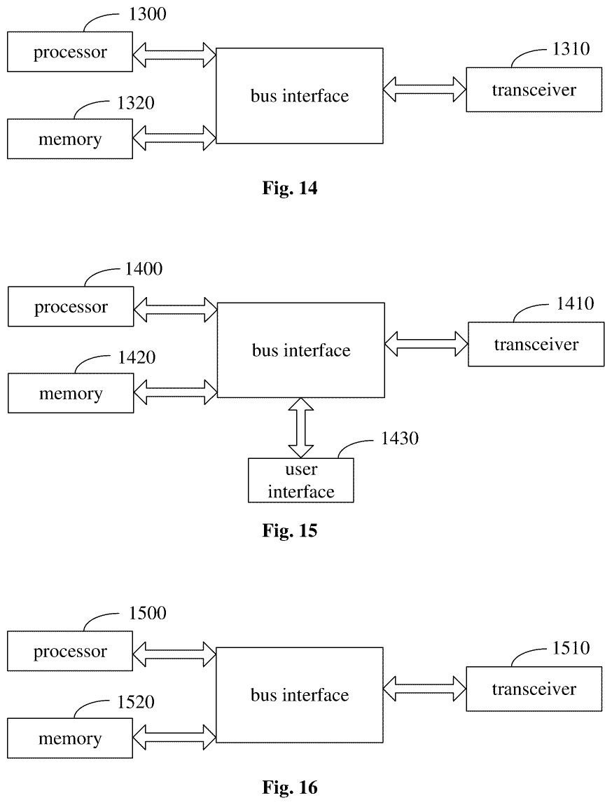

In order to achieve the above-mentioned purposes in a better manner, as shown in FIG. 15, the present disclosure further provides in this embodiment a mobile terminal, which includes a processor 1400, and a memory 1420 coupled to the processor 1400 via a bus interface and configured to store therein programs and data for the operation of the processor 1400. The processor 1400 is configured to call and execute the programs and data in the memory 1420.

A transceiver 1410 is coupled to the bus interface, and configured to receive and transmit data under the control of the processor 1400. The processor 1400 is configured to read the programs in the memory 1420.

To be specific, the transceiver 1410 is configured to receive pilot signals and positioning signaling transmitted by at least two RSUs. The positioning signaling includes an ID of each RSU, a timing adjustment value of each RSU and a timing offset value of each RSU, the timing adjustment value is an adjustment amount for synchronization between each RSU and a synchronization source when the positioning signaling is transmitted, and the timing offset value is a timing offset between the at least two RSUs. The processor 1400 is configured to determine a position in accordance with the positioning signaling.

In FIG. 15, bus architecture may include a number of buses and bridges connected to each other, so as to connect various circuits for one or more processors 1400 and one or more memories 1420. In addition, as is known in the art, the bus architecture may be used to connect any other circuits, such as a circuit for a peripheral device, a circuit for a voltage stabilizer and a power management circuit. The bus interface may be provided, and the transceiver 1410 may consist of a plurality of elements, i.e., a transmitter and a receiver for communication with any other devices over a transmission medium. With respect to different UEs, a user interface 1430 may also be provided for devices which are to be arranged inside or outside the UE, and these devices may include but not limited to a keypad, a display, a speaker, a microphone and a joystick. The processor 1400 may take charge of managing the bus architecture as well as general processings. The memory 1420 may store therein data for the operation of the processor 1400.

Optionally, the transceiver 1410 is specifically configured to receive the positioning signaling transmitted by the at least two RSUs through a PSCCH, or receive the positioning signaling transmitted by the at least two RSUs through the PSCCH and a PSSCH, or receive the positioning signaling transmitted by the at least two RSUs through the PSSCH. The pilot signal is a DMRS.

Optionally, when the positioning signaling is received transmitted by the at least two RSUs through the PSCCH and the PSSCH, the transceiver 1410 is specifically configured to receive a first portion of the positioning signaling transmitted by the at least two RSUs through the PSCCH, and receive a second portion of the positioning signaling transmitted by the at least two RSUs through the PSSCH. The first portion is used to indicate whether the positioning signaling is carried on the PSCCH, the second portion of the positioning signaling is carried on the PSSCH indicated by the PSCCH, and the second portion is used to indicate the ID of the RSU, the timing adjustment value of the RSU and the timing offset value of the RSU.

Optionally, the positioning signaling further includes position information about the RSU, and the position information about the RSU is indicated through the second portion.

Optionally, when the positioning signaling transmitted by the at least two RSUs through the PSSCH is received, the positioning signaling further includes position information about the RSU.

Optionally, the processor 1400 is further configured to determine position information about the at least two RSUs. When determining the position in accordance with the positioning signaling, the processor 1400 is specifically configured to: calculate a real offset value between the RSUs in accordance with the timing adjustment values of the at least two RSUs and the timing offset values of the at least two RSUs; and calculate the position of the mobile terminal in accordance with the position information about the at least two RSUs and the real offset value.

Optionally, when calculating the real offset value between the RSUs in accordance with the timing adjustment values of the at least two RSUs and the timing offset values of the at least two RSUs, the processor 1400 is specifically configured to calculate the real offset value between two RSUs through Rt_{xy}=(Ta_{xy}−Ta_{yx}−Tdₓ+Td_{y}−Δt_{xy}+Δt_{yx})/2, where x and y represent the two RSUs respectively, Rt_{xy} represents a real offset between x and y, Ta_{xy} represents a timing offset value of x that is relative to y and determined by x, Ta_{yx} represents a timing offset value of y that is relative to x and determined by y, Tdₓ represents a timing adjustment value of x, Td_{y} represents a timing adjustment value of y, Δt_{xy} represents a timing measurement error determined by x, and Δt_{yx} represents a timing measurement error determined by y.

According to the mobile terminal in this embodiment of the present disclosure, the timing offset values of the RSUs and the timing adjustment values of the RSUs in the positioning signaling are received from the RSUs, so as to obtain the real timing offset between the RSUs and achieve the positioning in a more accurate manner. As a result, it is able to prevent the occurrence of a timing drift between the RSUs due to a propagation delay of the signal caused by a propagation distance between the RSUs, thereby to increase the synchronization accuracy of the entire IoV system, and prevent the positioning accuracy of the OBU from being adversely affected.

### Ninth Embodiment

In order to achieve the above-mentioned purposes in a better manner, as shown in FIG. 16, the present disclosure further provides in this embodiment an RSU, which is a second RSU and includes a processor 1500, and a memory 1520 coupled to the processor 1500 via a bus interface and configured to store therein programs and data for the operation of the processor 1500. The processor 1500 is configured to call and execute the programs and data in the memory 1520.

A transceiver 1510 is coupled to the bus interface, and configured to receive and transmit data under the control of the processor 1500. The processor 1500 is configured to read the programs in the memory 1520.

To be specific, the transceiver 1510 is configured to receive a pilot signal and a positioning signaling transmitted by a first RSU. The positioning signaling includes an ID of the first RSU, a timing adjustment value of the first RSU and a timing offset value of the first RSU, the timing adjustment value is an adjustment amount for synchronization between the first RSU and a synchronization source when the positioning signaling is transmitted, and the timing offset value is a timing offset between the first RSU and the second RSU. The processor 1500 is configured to perform synchronization with the first RSU in accordance with the positioning signaling.

In FIG. 16, bus architecture may include a number of buses and bridges connected to each other, so as to connect various circuits for one or more processors 1500 and one or more memories 1520. In addition, as is known in the art, the bus architecture may be used to connect any other circuits, such as a circuit for a peripheral device, a circuit for a voltage stabilizer and a power management circuit. The bus interface may be provided, and the transceiver 1510 may consist of a plurality of elements, i.e., a transmitter and a receiver for communication with any other devices over a transmission medium. The processor 1500 may take charge of managing the bus architecture as well as general processings. The memory 1520 may store therein data for the operation of the processor 1500.

Optionally, when performing the synchronization with the first RSU in accordance with the positioning signaling, the processor 1500 is specifically configured to: determine a second timing offset value of the second RSU relative to the first RSU in accordance with the positioning signaling transmitted by the first RSU: determine a second timing adjustment value of the second RSU when the positioning signaling is received: calculate a real offset value between the second RSU and the first RSU in accordance with the first timing offset value, the first timing adjustment value, the second timing adjustment value and the second timing offset value; and perform the synchronization between the second RSU and the first RSU in accordance with the real offset value.

Optionally, when calculating the real offset value between the second RSU and the first RSU in accordance with the first timing offset value, the first timing adjustment value, the second timing adjustment value and the second timing offset value, the processor 1500 is specifically configured to calculate the real offset value between the second RSU and the first RSU through Rt_{xy}=(Ta_{xy}−Ta_{yx}−Tdₓ+Td_{y}+Δt_{yx}−Δt_{xy})/2, where x represents the second RSU, y represents the first RSU, Rt_{xy} represents a real offset between the second RSU and the first RSU, Ta_{xy} represents the first timing offset value, Ta_{yx} represents the second timing offset value, Tdₓ represents the second timing adjustment value, Td_{y} represents the first timing adjustment value, Δt_{xy} represents a timing measurement error determined by the first RSU, and Δt_{yx} represents a timing measurement error determined by the second RSU.

According to the RSU in this embodiment of the present disclosure, the positioning signaling is received from the first RSU, and a real timing offset between the first RSU and the second RSU is obtained in accordance with the timing offset value and the timing adjustment value in the positioning signaling, so as to achieve the synchronization between the RSUs in a more accurate manner, and achieve the synchronized collaboration between the RSUs even in the case that it is impossible to perform the time synchronization through a satellite signal and it is impossible to meet the requirement on high-accuracy time synchronization for a long time period when the accuracy of an internal clock of an IoV device is relatively low. As a result, it is able to prevent the occurrence of a timing drift between the RSUs due to a propagation delay of the signal caused by a propagation distance between the RSUs, thereby to increase the synchronization accuracy of the entire IoV system, and prevent the positioning accuracy of the OBU from being adversely affected.

It should be appreciated that, all of, or parts of, the steps may be implemented through hardware, or implemented through relevant hardware under the control of a computer program. The computer program may include instructions for executing parts of, or all of, the steps of the method, and it may be stored in a readable storage medium in any form.

It should be appreciated that, all of, or parts of, the steps may be implemented through hardware, or implemented through relevant hardware under the control of a computer program. The computer program may include instructions for executing parts of, or all of, the steps of the method, and it may be stored in a readable storage medium in any form.

In addition, the present disclosure further provides in some embodiments a computer-readable storage medium storing therein a computer program. The computer program is used to be executed by a processor to implement the steps of the above-mentioned method in the first embodiment, the second embodiment or the third embodiment with a same technical effect, which will thus not be particularly defined herein.

It should be appreciated that, according to the device and the method in the embodiments of the present disclosure, the members and/or steps may be subdivided and/or recombined, which shall also be deemed as equivalents of the present disclosure. In addition, the steps for executing the above-mentioned processings may be performed in a chronological order. It should be noted that, some steps may also be performed in parallel, or independently of each other. It should be further appreciated that, after reading the descriptions of the present disclosure, it is able for a person skilled in the art, using a basic programming skill, to implement any or all steps of the method and any or all members of the device in any computing device (including a processor and a storage medium) or a network consisting of the computing devices, in the form of hardware, firmware, software or a combination thereof.

Hence, the purposes of the present disclosure may also be implemented by one program or a set of programs running on any computing device, e.g., a known general-purpose computer, or implemented merely by a program product including programs codes capable of implementing the method or device. In other words, this program product and a storage medium storing therein the program product also constitute a part of the present disclosure. Obviously, the storage medium may be any known storage medium or a storage medium that may occur in future. It should be further appreciated that, according to the device and the method in the embodiments of the present disclosure, the members and/or steps may be subdivided and/or recombined, which shall also be deemed as equivalents of the present disclosure. In addition, the steps for executing the above-mentioned processings may be performed in a chronological order, but the present disclosure is not limited thereto. In addition, some steps may also be performed in parallel, or independent of each other.

The above are optional implementations of the present disclosure. It should be noted that a person skilled in the art can make various improvements and modifications without departing from the principle of the present disclosure. These improvements and modifications shall also be within the protection scope of the present disclosure.

1. A position determination method for a first Road-Side Unit (RSU), wherein the position determination method comprises:
transmitting a pilot signal and a positioning signaling,
wherein the positioning signaling comprises an Identity (ID) of the first RSU, a timing adjustment value of the first RSU and a timing offset value of the first RSU, wherein the timing adjustment value is an adjustment amount for synchronization between the first RSU and a synchronization source when the positioning signaling is transmitted, and the timing offset value is a timing offset between the first RSU and a second RSU.

2. The position determination method according to claim 1, wherein the transmitting the pilot signal and the positioning signaling comprises:
transmitting the positioning signaling through a Physical Sidelink Control Channel (PSCCH); or
transmitting the positioning signaling through the PSCCH and a Physical Sidelink Shared Channel (PSSCH); or
transmitting the positioning signaling through the PSSCH,
wherein the pilot signal is a DeModulation Reference Signal (DMRS).

3. The position determination method according to claim 2, wherein the transmitting the positioning signaling through the PSCCH and the PSSCH comprises:
transmitting a first portion of the positioning signaling through the PSCCH; and
transmitting a second portion of the positioning signaling through the PSSCH,
wherein the first portion is used to indicate whether the positioning signaling is carried on the PSCCH, the second portion of the positioning signaling is carried on the PSSCH indicated by the PSCCH, the second portion is used to indicate the ID of the first RSU, the timing adjustment value of the first RSU and the timing offset value of the first RSU.

4. The position determination method according to claim 3, wherein the positioning signaling further comprises position information about the first RSU;
the position information about the first RSU is indicated through the second portion.

5. The position determination method according to claim 3, wherein the first portion is carried through Sidelink Control Information (SCI).

6. The position determination method according to claim 2, wherein when the positioning signaling is transmitted through the PSSCH, the positioning signaling further comprises position information about the first RSU.

7. A position determination method for a mobile terminal, wherein the position determination method comprises:
receiving pilot signals and a positioning signaling transmitted by at least two RSUs, wherein the positioning signaling comprises an ID of each of the RSUs, a timing adjustment value of each of the RSUs and a timing offset value of each of the RSUs, wherein the timing adjustment value is an adjustment amount for synchronization between each of the RSUs and a synchronization source when the positioning signaling is transmitted, and the timing offset value comprising a timing offset between the at least two RSUs;
determining a position in accordance with the positioning signaling.

8. The position determination method according to claim 7, wherein the receiving the pilot signal and the positioning signaling transmitted by the at least two RSUs comprises:
receiving the positioning signaling transmitted by the at least two RSUs through a PSCCH; or
receiving the positioning signaling transmitted by the at least two RSUs through the PSCCH and a PSSCH; or
receiving the positioning signaling transmitted by the at least two RSUs through the PSSCH,
wherein the pilot signal is a DMRS.

9. The position determination method according to claim 8, wherein the receiving the positioning signaling transmitted by the at least two RSUs through the PSCCH and the PSSCH comprises:
receiving a first portion of the positioning signaling transmitted by the at least two RSUs through the PSCCH; and
receiving a second portion of the positioning signaling transmitted by the at least two RSUs through the PSSCH,
wherein the first portion is used to indicate whether the positioning signaling is carried on the PSCCH, the second portion of the positioning signaling is carried on the PSSCH indicated by the PSCCH, the second portion is used to indicate the ID of each of the RSUs, the timing adjustment value of each of the RSUs and the timing offset value of each of the RSUs.

10. The position determination method according to claim 9, wherein the positioning signaling further comprises position information about each of the RSUs;
the position information about each of the RSUs is indicated through the second portion.

11. The position determination method according to claim 8, wherein when the positioning signaling transmitted by the at least two RSUs through the PSSCH is received, the positioning signaling further comprises position information about each of the RSUs.

12. position determination method according to claim 7, further comprising:
determining position information about the at least two RSUs,
wherein the determining the position in accordance with the positioning signaling comprises:
calculating a real offset value between the RSUs in accordance with the timing adjustment values of the at least two RSUs and the timing offset values of the at least two RSUs;
calculating the position of the mobile terminal in accordance with the position information about the at least two RSUs and the real offset value.

13. The position determination method according to claim 12, wherein the calculating the real offset value between the RSUs in accordance with the timing adjustment values of the at least two RSUs and the timing offset values of the at least two RSUs comprises:
calculating the real offset value between the two RSUs through a following equation:
$${Rt}_{xy} = ( {Ta}_{xy} - {Ta}_{yx} - {Td}_{x} + {Td}_{y} - Δ {t}_{xy} + Δ {t}_{yx} ) / 2 ,$$
where x and y represent the two RSUs respectively, Rt_{xy} represents a real offset between x and y, Ta_{xy} represents a timing offset value of x that is relative to y and determined by x, Ta_{yx} represents a timing offset value of y that is relative to x and determined by y, Tdₓ represents a timing adjustment value of x, Td_{y} represents a timing adjustment value of y, Δt_{xy} represents a timing measurement error determined by x, and Δt_{yx} represents a timing measurement error determined by y.

14. A synchronization method for a second RSU, comprising:
receiving a pilot signal and a positioning signaling transmitted by a first RSU, the positioning signaling comprising an ID of the first RSU, a first timing adjustment value of the first RSU and a first timing offset value of the first RSU, the first timing adjustment value being an adjustment amount for synchronization between the first RSU and a synchronization source when the positioning signaling is transmitted, and the first timing offset value being a timing offset between the first RSU and the second RSU;
performing synchronization with the first RSU in accordance with the positioning signaling.

15. The synchronization method according to claim 14, wherein the performing the synchronization with the first RSU in accordance with the positioning signaling comprises:
determining a second timing offset value of the second RSU relative to the first RSU in accordance with the positioning signaling transmitted by the first RSU;
determining a second timing adjustment value of the second RSU when the positioning signaling is received;
calculating a real offset value between the second RSU and the first RSU in accordance with the first timing offset value, the first timing adjustment value, the second timing adjustment value and the second timing offset value;
performing the synchronization between the second RSU and the first RSU in accordance with the real offset value.

16. The synchronization method according to claim 15, wherein the calculating the real offset value between the second RSU and the first RSU in accordance with the first timing offset value, the first timing adjustment value, the second timing adjustment value and the second timing offset value comprises:
calculating the real offset value between the second RSU and the first RSU through a following equation:
$${Rt}_{xy} = ( {Ta}_{xy} - {Ta}_{yx} - {Td}_{x} + {Td}_{y} + Δ {t}_{yx} - Δ {t}_{xy} ) / 2 ,$$
where x represents the second RSU, y represents the first RSU, Rt_{xy} represents a real offset between the second RSU and the first RSU, Ta_{xy} represents the first timing offset value, Ta_{yx} represents the second timing offset value, Tdₓ represents the second timing adjustment value, Td_{y} represents the first timing adjustment value, Δt_{xy} represents a timing measurement error determined by the first RSU, and Δt_{yx} represents a timing measurement error determined by the second RSU.

17. (canceled)

18. (canceled)

19. (canceled)

20. An RSU, which is a first RSU and comprises a transceiver, a memory, a processor and a computer program stored in the memory and used to be executed by the processor, wherein the processor is configured to execute the computer program to implement steps of the position determination method according to claim 1.

21. A mobile terminal, comprising a transceiver, a memory, a processor and a computer program stored in the memory and used to be executed by the processor, wherein the processor is configured to execute the computer program to implement steps of the position determination method according to claim 7.

22. An RSU, which is a second RSU and comprises a transceiver, a memory, a processor and a computer program stored in the memory and used to be executed by the processor, wherein the processor is configured to execute the computer program to implement steps of the synchronization method according to claim 14.

23. A computer-readable storage medium storing therein a computer program, wherein the computer program is used to be executed by a processor to implement steps of the position determination method according to claim 1.
